(19) United States
(12) Patent Application Publication
(10) Pub. No.: US 2014/0310108 A1
(43) Pub. Date: Oct. 16, 2014

(54) Method for Providing Advertisement Posting Service To Display Advertisement on User-Set Advertisement Display Area

(71) Applicants: Jeong Yul Ryu, Seoul (KR); Hea Young Park, Seongnam-si (KR)

(72) Inventors: Jeong Yul Ryu, Seoul (KR); Hea Young Park, Seongnam-si (KR)

(21) Appl. No.: 14/354,826

(22) PCT Filed: Oct. 26, 2012
(86) PCT No.: PCT/KR2012/008851

§ 371 Date: Apr. 28, 2014

(30) Foreign Application Priority Data
Oct. 28, 2011 (KR) 10-2011-0111253
Aug. 30, 2012 (KR) 10-2012-0095768

(51) Int. Cl. G06Q 30/02

(52) U.S. Cl. CPC G06Q 30/0276
USPC 705/14.72

(57) ABSTRACT

In a user terminal, an app having a function for assigning a pre-determined area on the screen of the user terminal as an advertisement posting area, and a function for receiving said set-up instruction in order to designate said advertisement posting area, is installed. When an advertisement agent server receives a set-up instruction from a user terminal, the advertisement server sends the advertisement to the user terminal, thus the advertisement is displayed on the advertisement posting area which is set up in accordance with the set-up instruction by the app. User inconveniences are minimized by posting advertisement on a user designated area.

### TECHNICAL FIELD

This invention relates to a method for providing an advertising service, more particularly, to a method for providing an advertising service wherein the contents of the advertisement are being displayed on a user designated area of the user terminal.

### BACKGROUND ART

Various kinds of contents are provided on websites. For example, portal websites and the like providing such contents, are earning income by collecting advertisement fees from the advertisers for displaying advertisements with other contents for the users reading the contents. To date, methods for advertisements have been focusing on the way how to obtain maximum advertisement effect for the advertiser at a low cost in order to maximize the effect of the advertisement. In order to achieve this goal, various methods have been suggested for so called targeting advertisement; among others, there is a method for attaching advertisement to the contents containing the corresponding keywords provided by the advertiser, or a method for attaching an advertisement related to the corresponding keywords when a user enters keywords for search, or the like.

However, in such an advertising method of the prior art, there is a problem in that advertisements are being provided only with the perspectives of a portal website or an advertiser and the like who can provide search functions. Users are exposed to various advertisements, irrelevant to the intensions or the necessities of the users, on the screens of the portal websites while searching, thereby causing many user inconveniences. Such inconveniences are mainly caused by posting advertisement on various locations in the screen (for example, advertisements are posted on various locations including sides and bottom using various methods, and even half-transparent advertisements are posted in the middle of the contents, and the like) disregarding user intention.

Especially the half-transparent advertisements covering contents to be reviewed by a user, and the like are causing many user inconveniences in reading the contents. Thus, it is necessary to provide a method wherein advertisements are displayed on a location preferred by a user considering the perspective of the user.

In addition, a user does not get any compensation for being exposed to advertisements in such a way according to the advertising methods of the prior art.

Moreover, in the advertising methods of the prior art, advertisements in the field of user interest, which are not being considered as user inconveniences since the advertisements are practically necessary for the user, are not being posted. Providing an advertisement practically necessary for a user is beneficial for both the advertiser and the user since it provides an efficient advertisement at a low cost with perspectives of user and advertiser as well, therefore a proper method is needed to attain this end.

Furthermore, since advertisements are posted at anytime according to the advertising methods of the prior art, a user had to be exposed to advertisements without being considered whether it is right time or inappropriate time for viewing the advertisements from the user perspective.

### SUMMARY OF INVENTION

### Technical Problem

An objective of the present invention, devised to solve above described problems, is to provide a method for minimizing user inconveniences by posting advertisements on a user designated area.

Another objective of the present invention is to provide a method for maximizing the conveniences of a user, and besides, receiving user compensation for viewing advertisements; such as posting an advertisement at a time preferred by the user in the field of user interest, and the like.

### Solution to Problem

Above described objectives can be achieved by a method for providing an advertisement posting service characterized in that and including the steps of:

a) transferring set-up instruction to an advertisement agent server from a user terminal installed with an application program (hereinafter referred to as ‘app’) having a function for assigning a pre-determined area on the screen of the user terminal as an advertisement posting area, and a function for receiving said set-up instruction in order to assign said advertisement posting area; and

b) displaying an advertisement, using said app, on said advertisement posting area, which is assigned according to said set-up instruction, on said screen of said user terminal by sending the advertisement from said advertisement agent server to said user terminal.

Herein said set-up instruction includes instruction for setting up the relevant requirements involved in posting advertisement on said advertisement posting area.

Multiple numbers of said advertisement posting area are preserved, and said set-up instruction includes an area set-up instruction for selecting more than any one of said advertisement posting area.

Said set-up instruction includes:

a time set-up instruction which is a selection instruction for the time to display an advertisement on said advertisement posting area;

a requirement set-up instruction for setting-up the requirements corresponding to the advertisement type to be displayed on said advertisement posting area;

a location set-up instruction which is an instruction to notify the location entered into the user terminal by the user to said advertisement agent server by transferring, or to permit said advertisement agent server to collect the location of said user terminal; and

a screen selection instruction for displaying said advertisement only on a specified screen among the screens displayed on said user terminal.

In a portion of said advertisement posting area, a time displaying area may be provided for displaying the time information about the time during which said advertisement has been displayed on said advertisement posting area.

Said step b) may include the steps of:

b-1) selecting said advertisement by said advertisement agent server in accordance with the requirements set-up by said set-up instruction; and

b-2) transferring selected said advertisement to said user terminal by said advertisement agent server.

### Advantageous Effects of Invention

According to the present invention, user inconveniences are minimized by posting advertisement on a user designated area. Furthermore, an advertisement can be posted at a time preferred by the user in the field of user interest.

### BRIEF DESCRIPTION OF DRAWINGS

FIG. 1 is an illustration showing an overall system wherein a method for providing advertisement posting service is performed according to the present invention.

FIG. 2 is an illustration showing the processes performed by the system in FIG. 1.

FIG. 3 is an illustration showing an example of a displayed screen when an app is being performed on a user terminal.

FIG. 4 is an illustration showing an example of the screen displayed on a user terminal in FIG. 2.

### DESCRIPTION OF EMBODIMENTS

Hereinafter, the present invention will be described more in detail with reference to the accompanying drawings.

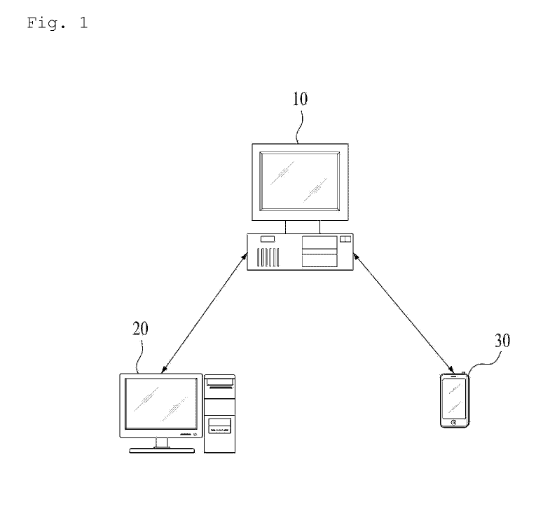

FIG. 1 is an illustration showing an overall system wherein a method for providing advertisement posting service is performed according to the present invention. The overall system is comprised of an advertisement agent server 10, an advertiser terminal 20, and a user terminal 30.

An advertisement agent server 10 is a server performing advertisement posting service according to the present invention. Such an advertisement agent server 10 may be a server of an advertisement agency who exclusively perform advertisement agent work, or a server itself operating a portal website, or a server operating individual website. Furthermore, an advertisement agent server 10 is not limited to a server providing advertisements in a wire communication network, but includes a server providing advertisements in a wireless internet network such as mobile phones, smart phones, or tablet PCs and the like.

An advertiser terminal 20 is a terminal operated by an advertiser who wants to expose an advertisement to general users, it may be comprised of a regular sever or a personal computer, or a terminal capable of data communication via a wire or a wireless internet network involving mobile phones, smart phones, or tablet PCs and the like.

A user terminal 30 is a terminal viewing advertisements provided by the advertisement agent server 10; similarly, it can be comprised of a regular computer or a mobile terminal, and it may also include all kinds of terminals capable of viewing advertisement via wire or wireless internet networks such as IPTVs and the like. FIG. 1 illustrates an example wherein a smart phone is used as a user terminal 30.

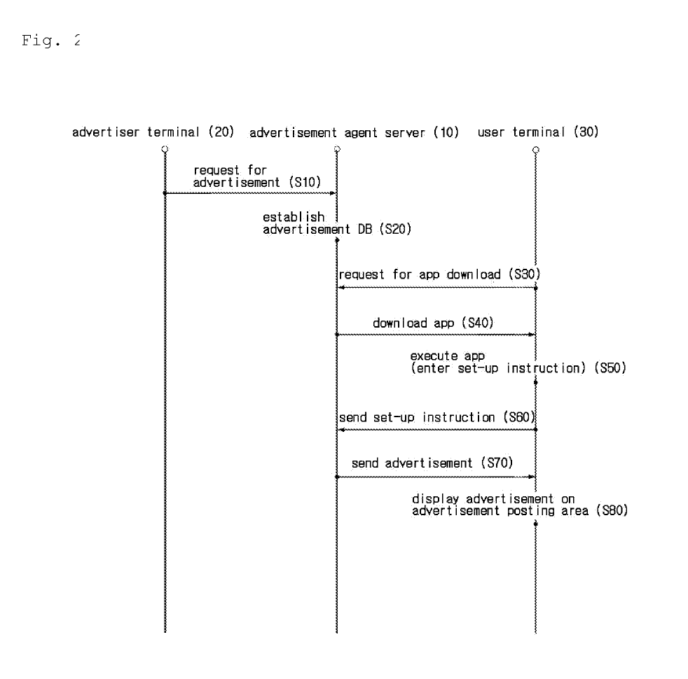

FIG. 2 is an illustration showing the overall process of a method for providing advertisement posting service according to the present invention performed by the system in FIG. 1.

An advertisement agent server 10 should have contents to be provided for an advertisement which is received from an advertiser in advance. In other words, when an order for an advertisement agent work is received (S10) from an advertiser terminal 20, the advertisement agent server 10 receives an advertisement from the advertiser terminal 20, and establishes a database for the advertisement (S20).

At this time, the advertisement agent server 10 classifies and sets up keywords for the advertisement, and stores them therein. For goods, for example, it can be classified as, electronic product, clothing, food, furniture, and the like; for business types, it can be classified as medical service, travel, restaurant, and the like. Keywords should be suitable ones for posting the advertisement of the advertiser; for example, if an advertisement is for advertizing a dental hospital, the keywords can be set-up as tooth, pain, implant, artificial teeth, and the like. Such classifications and keywords are used in selection of an advertisement matched with the requirements which had been set-up when a user sets up the requirements for receiving advertisement as described hereinafter. Determination of the keywords or classification may be performed by the advertiser or by the advertisement agent server 10.

For setting up advertisement posting areas for a user, first a specific app must be installed in the user terminal 30.

The most important function of this app is to assign a designated area on a display screen of the user terminal 30 as an advertisement posting area. In addition, this app performs a function for receiving set-up instruction for setting up an advertisement posting area from the users, and transferring this to the advertisement agent server 10. At this time, the set-up instruction includes instruction for setting up the relevant requirements needed for posting advertisement on the advertisement posting area. The detailed functions of the app will be described hereinafter.

When a user terminal 30 requests downloading of the app to the advertisement agent server 10 (S30), the advertisement agent server 10 sends app file to the user terminal 30; thus the user terminal 30 can download the app (S40); after the user executes the app installed in the user terminal 30, said set-up instruction are entered according to the menu provided by the app (S50). In this exemplary embodiment of the present invention, although it is described that apps are downloaded from the advertisement agent server 10, for example, if the user terminal 30 is a smart phone as shown in FIG. 1, usually apps are developed by the operator of the advertisement agent server 10 and uploaded to app markets such as so-called app stores or android market and the like, then the user terminal 30 may download from such an app market.

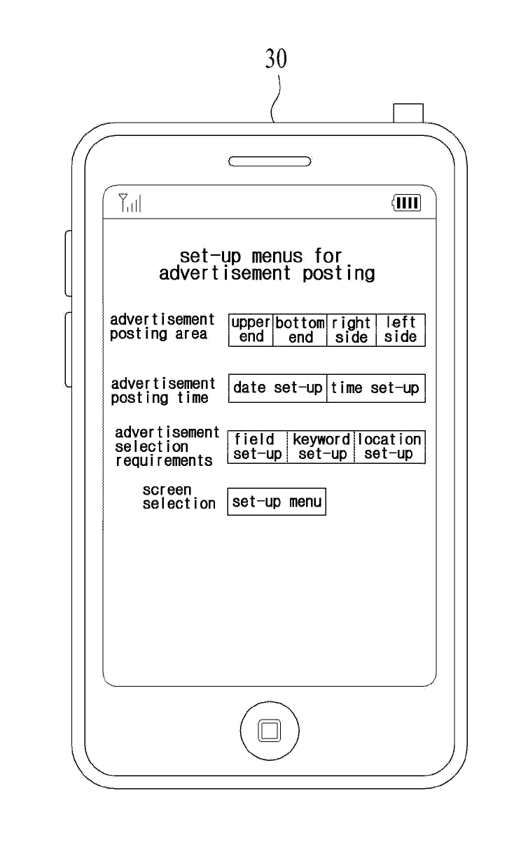

FIG. 3 illustrates an example of a screen provided by an app when the app is being executed in step S50.

On the screen of a user terminal 30, there is a menu that selects an advertisement posting area. The ‘advertisement posting area’ menu is configured to set-up four areas such as upper end, bottom end, right side, and left side. A user can input area set-up instruction by selecting and clicking on any one among the individual areas; thus, corresponding area on the screen of the user terminal 30 is set-up as an advertisement posting area. For example, if a user selects ‘bottom end’ an advertisement posting area is set-up as a 2 cm high strip-like shape at the bottom end of the screen.

In addition to the menu that selects an advertisement posting area, there are menus for input options for advertisement posting time, advertisement selection requirements, display screen selection, and the like.

A menu for ‘advertisement posting time’ is to set-up time by a user when the advertisement is displayed on the user terminal 30, and comprised of detailed set-up menus ‘date set-up’ and ‘time set-up.’ When the menu ‘date set-up’ is clicked, an input screen for entering a date when the advertisement should be displayed on the user terminal 30 is displayed. It is preferred that date may be entered with various set-up options such as ‘range of dates,’ ‘day of week,’ ‘months,’ and the like. When the menu ‘time set-up’ is clicked, an input screen for entering a time when the advertisement should be displayed on the user terminal 30 is displayed. When time is set-up, an advertisement is displayed only within the range of time, which is set-up by ‘time set-up,’ on the dates, which are set-up by ‘date set-up.’ Thus, inputting of time set-up instruction is completed by entering date and time.

A menu ‘advertisement selection requirements’ is a menu for a user entering a requirement set-up instruction which sets up requirements on types of advertisement to be displayed on the advertisement posting area on the display screen of the user terminal 30; and comprised of detailed menus such as ‘field set-up,’ ‘keywords set-up,’ ‘location set-up,’ and the like.

‘Field set-up’ is a menu for selecting one or more among the list of names of detailed categories wherein advertisement is classified, for example, names such as electronic product, clothing, food, furniture, medical service, travel, restaurant, and the like, which are set-up for each advertisement as described above, are provided to be selected. If a user has interests in travel and clothing, he could selectively receive advertisement only related to travel and clothing by clicking ‘field set-up’ and thereafter selecting travel and clothing.

‘Keyword set-up’ is a menu for selecting desired advertisement for a user using keyword matching method based on the keywords assigned to each advertisement among the established advertisement database as described above; to be more specific, by analyzing characters being inputted in real time by the user using the user terminal 30 thereof, for example, if characters ‘tooth,’ ‘pain,’ ‘implant,’ and the like are included in the input characters, an advertisement, where the characters are allocated among the keywords allocated for advertisement as described above, is selected and displayed on the user terminal 30.

‘Location set-up’ is a menu for selecting an advertisement matched with the corresponding location based on the location set-up by the user terminal 30; two types of methods, individual set-up and automatic set-up, are available. Individual set-up is a method wherein set-up is accomplished by directly inputting a location by the user, for example, if a user having a travel plan visiting Jeju Island wants to see advertisement related to Jeju Island, location can be set-up as Jeju Island. Automatic set-up provides advertisement matching with the location of the user terminal 30 which is automatically figured out by the advertisement agent server 10, for example, if the present location of a user is an entertainment district in front of Hongik University, advertisement about the clubs in front of Hongik University may be automatically selected and provided to the user terminal 30. In order to implement such an automatic location set-up, a process for obtaining approval from the user for collecting location information of the user terminal 30 may further be performed according to a legal requirement.

‘Display screen selection’ is a menu for entering a screen selection instruction which allows displaying of an advertisement only on a designated screen among the screens displayed on the user terminal 30. A user may want advertisement to be displayed under a specific condition, but may not want advertisement to be displayed under the other conditions while using the user terminal 30. For example, a user may feel all right about displaying the advertisement while a home screen or a search screen is being displayed on the user terminal 30, however may not want the advertisement to be displayed on a game screen or when other application programs are being executed. Thus, when setting up whether to display advertisement or not in accordance with the type of the screen (or type of the program being executed), the set-up menu of ‘display screen selection’ menu is clicked, then, a detailed menu for selecting detailed item as described above is displayed through the execution of the set-up menu; by setting up a desired item for a user in this detailed menu, for example, no advertisement is being displayed while the user enjoys a game.

Furthermore, a set-up menu for ‘advertisement posting area’ as described above can be attached under the ‘screen selection’ menu such that the advertisement posting area may be different for each display screen. In other words, a user sets up a ‘display screen selection’ menu such that advertisement is being posted only on the home screen and the search screen, it may be set-up such that advertisement is displayed on the right side of the display screen while the home screen is being displayed, and advertisement is displayed on the bottom end of the display screen while the search screen is being displayed.

In addition, by adding a set-up menu for ‘advertisement selection requirement’ to each display screen displayed by ‘display screen selection’ menu, selection requirements of the advertisement may be different for each display screen. In other words, a user may set-up using the ‘display screen selection’ menu such that advertisement is posted only on the home screen and the search screen, and set-up a field such that only advertisement related to ‘travel’ is selected for the advertisement displayed on the home screen, and keywords may be set-up such that advertisement displayed on the search screen is to be selected by keyword matching method.

In a similar manner, it can be set-up such that ‘advertisement selection requirement’ may vary for each ‘advertisement posting area.’ A user may select ‘bottom end’ and ‘upper end’ as ‘advertisement posting areas,’ wherein advertisement for the ‘upper end’ is selected using field set-up method, while advertisement for the ‘bottom end’ is selected by keyword matching method.

It may be set-up such that advertisement is displayed on the right side of this display screen, and displayed on the bottom end while search screen is being displayed.

Meanwhile, in such menus, as described above, for selecting an advertisement posting area or a display screen, a separate menu capable of assigning order for an area or a display screen, may be added. For example, an ‘area order set-up’ menu can be added such that ‘advertisement posting area’ changes in the order of ‘upper end,’ ‘bottom end,’ ‘left side,’ ‘right side’ every time when each individual advertisement is being displayed; and in selecting a display screen, a ‘display screen order set-up’ menu can be added for setting up the order of the screen such that advertisement is displayed in the order of home screen, search screen, specific application program execution screen.

After the user finishes entering all the inputs for such selection menus related to advertisement posting, the user transfers set-up instruction including the relevant information entered through manipulating the user terminal 30 to the advertisement agent server 10 (S60).

The advertisement agent server 10, which receives the set-up instruction, extracts advertisement matching with the set-up instruction. In other words, advertisement matching with the user is selected by aggregating field, keywords, location information, and the like based on the set-up instruction for advertisement selection requirements. Then, the advertisement agent server 10 transfers the selected advertisement to the user terminal 30. At this time, it is preferred that the advertisement agent server 10 transfers advertisement at the time set-up by the user based on the set-up instruction for advertisement posting time.

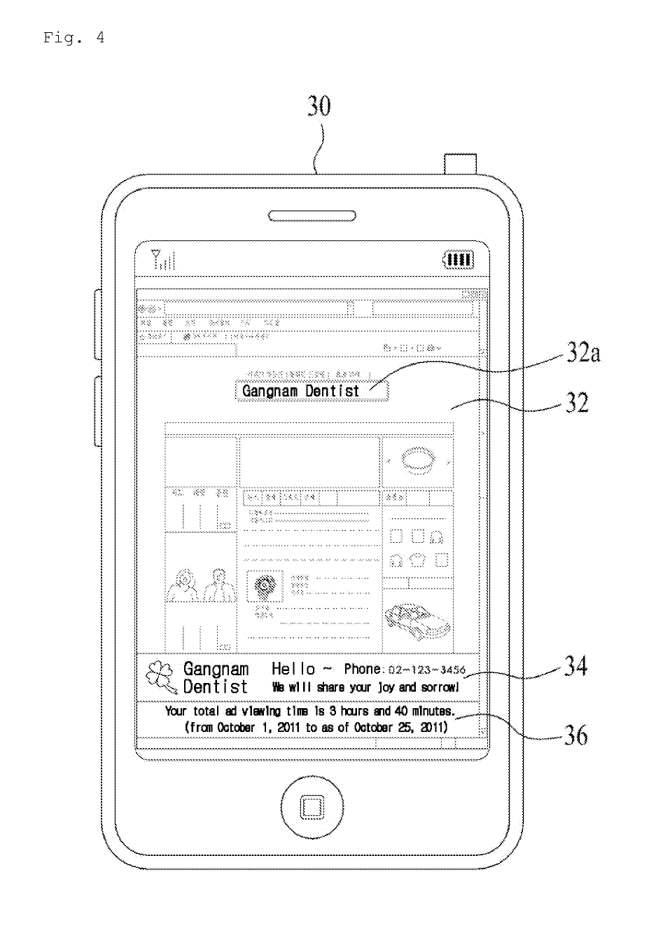

FIG. 4 is an illustration showing an example of the screen displayed on a user terminal in FIG. 2, more particularly, shows an example wherein the user had set-up ‘bottom end’ of the screen as an advertisement posting area, and keywords set-up method as a requirement for selecting an advertisement.

In the main screen 32 on the display screen of the user terminal 30, an execution screen of a program which is presently being driven is displayed. The program which is presently being driven is a homepage screen of a portal website, wherein a search window 32a is present on the upper area. A strip-like advertisement posting area 34 is present at the bottom area of the main screen 32, an advertisement is displayed on this advertisement posting area 34.

Thus, when an advertisement posting area 34 is allocated, displaying an advertisement on said advertisement posting area is accomplished by the function of the app as described above. In other words, the app displays advertisement by overwriting an advertisement on the present display screen for the area allocated as an advertisement posting area 34 among the whole image being displayed on the present display screen. In this way, in the advertisement posting area 34, only the advertisement can be visually perceivable since advertisement is displayed as overwritten on the present display screen. Of course the screen in the advertisement posting area 34 will be displayed passing through the advertisement in a visually perceivable form when the image of the advertisement is configured to be half transparent.

Meanwhile, in FIG. 4, an example, wherein characters ‘Gangnam Dentist’ are entered by a user on the search window of the portal website, which is the present display screen, is illustrated. The characters ‘Gangnam’ and ‘Dentist’ entered into the search window are read by the app and being transferred to the advertisement agent server 10 in real time; the advertisement agent server 10 extracts advertisement registered with keywords ‘Gangnam’ and ‘Dentist’ based on the transferred characters, and transfers them to the user terminal 30; The transferred advertisement is displayed on the advertisement posting area 34 by the app as illustrated in FIG. 4. Thus, a user can get the result such that the advertisement matching with the corresponding keywords is displayed at the same time the user enters search keywords for searching.

In this way, an app can read characters entered by a user using user terminal 30 thereof, and transfer them to the advertisement agent server 10; various methods may be used for apps in reading characters.

For example, a character string (for example, a character string being entered on a word processor, a character string being entered for transferring as a user text message on a screen for text message transfer, and the like) entering into the program being executed by the present user terminal 30 can be read; unlike this, when the user enters characters using a keyboard, a character string entered by the user can be read by detecting pressed keypads of the keyboard (in other words, by detecting data being transferred from the keyboard).

In addition, according to the present invention, it is also possible to apply keyword matching method in advertisement extraction only for the characters being entered into the search window as illustrated in FIG. 4. In other words, text strings being entered by the user for sending text messages or text strings being entered when using a word processor are not used in keyword matching advertisement extraction, only characters being entered into the search window may be used in keyword matching advertisement extraction. For implementation of this method, the app should have a function to determine whether the characters are being entered with the cursor being positioned on the search window by analyzing HTML of the display screen displayed on the present user terminal 30.

Meanwhile, FIG. 4 illustrates an example wherein a time display area 36 is prepared at the bottom end of the advertisement posting area 34. This time display area 36 displays total elapsed posting time of the advertisement on the user terminal 30, for example, total posting time of the advertisement during the period on a monthly basis including present date as illustrated in FIG. 4, is informed to the user. Such time information may be calculated and displayed by an app, or calculated by the advertisement agent server 10 and may be transferred to the user terminal 10. In the former case, it is advantageous in that time information should be separately calculated by the app for each advertisement and transferred to the advertisement agent server 10, in this way, the advertisement agent server 10 can figure out the time during which the advertisement has been posted on the user terminal 30, thus it can be utilized in calculation of the advertisement cost for the advertiser; in addition, compensation cost for the user of the user terminal 10 for viewing the advertisement can be calculated using the total time of advertisement.

According to the present invention, since advertisement can be displayed in an advertisement posting area, which is pre-set by a user, many inconveniences caused by posted advertisement can be mitigated. At this time, since the user sets up the advertisement posting area and types and times of the advertisement as well, only the advertisement related to the desired field of the user can be transferred at a desired time. Thus, from the perspective of an advertiser, a targeting advertisement becomes possible at a low cost.

At this time, as a reward for a user who had been working actively in setting up various requirements for the advertisement; and as a reward for a user for receiving and viewing the advertisement, some portion of the advertisement fees received from the advertiser can be fed back to the user. This method can motivate users for more active viewing of the advertisement, and enhances the effectiveness of the advertisement. Feed back of the advertisement fees can be accomplished in various ways, for example, supporting some portion of communication service charge in cooperation with the mobile communication service providers, and the like.

Meanwhile, in the above described exemplary embodiment, the advertisement agent server 10 is described as a server of an independently existing advertisement agency. In this case, the advertisement agent server 10 can be configured as an independent server providing advertisement in collaboration with a mobile communication service provider (for mobile communication terminals) or an internet service provider (ISP) (for terminals in a wired internet) by recruiting advertisers independently; unlike this, in cooperation with a web server (not shown) operating a portal website, an advertisement agent service in a portal website can be performed on the advertisement posting area. Furthermore, this advertisement agent server 10, for example, may be virtually comprised of a web server itself, which is operating a portal website, through the embodiment with the advertisement agent server in a functionally integrated form; Scope of claims of the present invention shall be construed to include above described example.

### Description of Symbols

10: advertisement agent server
20: advertiser terminal
30: user terminal

1. A method for providing an advertisement posting service characterized in that and including the steps of:
a) transferring set-up instruction to an advertisement agent server from a user terminal having a function for assigning a designated area on the whole display area of the user terminal as an advertisement posting area, and a function for receiving said set-up instruction in order to assign relevant requirements related to posting said advertisement on said advertisement posting area; and
b) displaying an advertisement on said advertisement posting area, which is assigned according to said set-up instruction, on said whole display area of said user terminal by sending the advertisement from said advertisement agent server to said user terminal, wherein displaying of said advertisement is an independent operation irrelevant to the currently operating application program, advertisement also can be displayed in such a way that the currently operating application program is being overlapped by advertisement;
said set-up instruction includes a requirement set-up instruction for setting up the selection requirement of the advertisement to be displayed on said advertisement posting area; and
said requirement set-up instruction further includes a function for separately setting up selection requirements of the advertisement according to the type of the application program (types such as search program, gaming program, word processor program, and the like) operating in the user terminal.

2. A method for providing an advertisement posting service according to claim 1, being characterized in that said set-up instruction includes a screen selection instruction for individually setting up whether to display said advertisement or not in accordance with the application program operating in said user terminal.

3. A method for providing an advertisement posting service according to claim 2, being characterized in that said set-up instruction includes a set-up function for displaying an advertisement and the advertisement selection requirements on the main display screen under the condition when no application program is being executed.

4. A method for providing an advertisement posting service according to claim 2, being characterized in that said set-up instruction further includes a function for individually setting up a user preferred advertisement posting area in accordance with the type of an application program.

5. A method for providing an advertisement posting service according to claim 1, being characterized in that multiple numbers of advertisement posting areas are preserved in the whole screen of a user terminal, and said set-up instruction includes an area set-up instruction for selecting more than any one of said advertisement posting area.

6. A method for providing an advertisement posting service according to claim 5, being characterized in that said set-up instruction includes a function for individually setting up advertisement selection requirements for each advertisement posting area of said multiple advertisement posting areas.

7. A method for providing an advertisement posting service according to claim 1, being characterized in that said set-up instruction includes a time selection instruction for selecting time for displaying an advertisement in said advertisement posting area.

8. A method for providing an advertisement posting service according to claim 1, being characterized in that said set-up instruction includes a location set-up instruction which is an instruction to notify the desired location, entered into the user terminal by a user, to said advertisement agent server by transferring, or to permit said advertisement agent server to collect information on the present location of said user terminal.

9. A method for providing an advertisement posting service according to claim 1, being characterized in that, in a portion of said advertisement posting area, a time displaying area is provided for displaying the time information about the time during which said advertisement has been displayed on said advertisement posting area.
